(19) United States
(12) Patent Application Publication
(10) Pub. No.: US 2026/0113381 A1
(43) Pub. Date: Apr. 23, 2026

(54) INTELLIGENT USER SESSION MANAGEMENT METHOD FOR LARGE SCALE HYBRID CLOUD SYSTEMS

(71) Applicant: SAP SE, Walldorf (DE)

(72) Inventor: Jianping Zhong, Shanghai (CN)

(21) Appl. No.: 18/918,506

(22) Filed: Oct. 17, 2024

(51) Int. Cl. H04L 67/146

(52) U.S. Cl. CPC H04L 67/146

(57) ABSTRACT

A first request is received from a first computing device for access to a first cloud service, where the first request includes a first type of session parameter. Next, the first type of session parameter is mapped, via a unified user session mapping table, to either a second type of session parameter or a third type of session parameter based on an identity and/or service type of the first cloud service. Then, a modified first request is generated by replacing the first type of session parameter with either the second or third type of session parameter. Next, the modified first request is forwarded to the first cloud service. Then, the first cloud service retrieves either the second type of session parameter or the third type of session parameter from the modified first request to establish and/or maintain a secure user session with the first computing device.

### TECHNICAL FIELD

The present disclosure generally relates to efficiently and intelligently managing user sessions in hybrid cloud systems.

### BACKGROUND

In today's cloud system development landscape, hybrid cloud systems often include a mix of monolith applications and microservices. On one hand, more and more companies are investing into microservices for their new features and functionalities. On the other hand, many revenue generating functionalities are still rooted in monolith applications where a complete rewrite of them into microservices is simply mission impossible. As a result, it would be beneficial to develop an efficient system for allowing software providers to leverage both monolithic application and microservice applications together so that from a user's perspective, it's just one system providing a harmonized set of functionalities.

### SUMMARY

In some implementations, a first request is received from a first computing device for access to a first cloud service, where the first request includes a first type of session parameter. Next, the first type of session parameter is mapped, via a unified user session mapping table, to either a second type of session parameter or a third type of session parameter based on an identity and/or service type of the first cloud service. Then, a modified first request is generated by replacing the first type of session parameter with either the second or third type of session parameter. Next, the modified first request is forwarded to the first cloud service. Then, the first cloud service retrieves either the second type of session parameter or the third type of session parameter from the modified first request to establish and/or maintain a secure user session with the first computing device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a computing system, in accordance with some example implementations of the current subject matter;

FIG. 2 illustrates a diagram of a process flow through a hybrid resource platform, in accordance with some example implementations of the current subject matter;

FIG. 3 illustrates a diagram of another process flow through a hybrid resource platform, in accordance with some example implementations of the current subject matter;

FIG. 4 illustrates a diagram of another process flow through a hybrid resource platform, in accordance with some example implementations of the current subject matter;

FIG. 5 illustrates a diagram of another process flow through a hybrid resource platform, in accordance with some example implementations of the current subject matter;

FIG. 6 illustrates a diagram of another process flow through a hybrid resource platform, in accordance with some example implementations of the current subject matter;

FIG. 7 illustrates a diagram of a user session management service, in accordance with some example implementations of the current subject matter;

FIG. 8 illustrates a block diagram of a generic resource platform, in accordance with some example implementations of the current subject matter;

FIG. 9 illustrates an example of a process for employing a hybrid user session management service, in accordance with some example implementations of the current subject matter;

FIG. 10 illustrates an example of a process for managing unified user sessions, in accordance with some example implementations of the current subject matter;

FIG. 11 illustrates an example of a process for utilizing a unified user session mapping table, in accordance with some example implementations of the current subject matter;

FIG. 12A depicts an example of a system, in accordance with some example implementations of the current subject matter; and

FIG. 12B depicts another example of a system, in accordance with some example implementations of the current subject matter.

### DETAILED DESCRIPTION

In today's cloud system development landscape, hybrid cloud systems which are mixed with multiple microservices as well as monolith applications are not rare. While more companies are investing in microservices for their new features and functionalities, many revenue generating functionalities are still rooted in monolith applications. Many monolith applications rely on application specific HTTP sessions and different monolith application may have different HTTP session identifiers. Thus, a user may have multiple sessions operating concurrently with multiple monolith applications. As a session is typically managed on the server side, the use of multiple applications/servers may require multiple session control features. Alternatively, microservices usually don't rely on sessions, but rather take advantage of JavaScript Object Notation (JSON) web tokens (JWTs) for identifying users as well as for authentication and authorization. A token, once created, is typically stored on the client or user device and is used to verify that device for one or more microservices. As the token is transmitted to the client for further distribution to microservices, token management relies more on the client device than session management. As the user just needs access to an application, but will not know if the application is a monolithic application or a microservices based application, it is important to provide access controls to a user that can accommodate both session and token-based interactions. Accordingly, connections are needed between user sessions and JWT tokens. Though this can be tackled by writing various cookies into user browsers, it would be complex to set up and may not be implemented if a user blocks the download of some cookies. In addition, single sign-on and single logout are often left unimplemented such that the user experience would not be efficient or, in some cases, provide needed functionality.

To address the deficiencies in the prior art, an intelligent user session management service is proposed herein to automatically handle all user request related requirements including authentication, single sign-on, and single logout as well as cookie management. The proposed method involves closely integrating a user session management service with the gateway. This integration allows user requests to be intercepted and, whenever necessary, a global user session (i.e., a unified user session) can be created that can be used to infer JWT tokens and application specific HTTP sessions that are required by all the microservices and monolith applications. This method not only provides a way to manage JWT tokens and application specific HTTP sessions under a single user session but also simplifies cookie management. Hence, this avoids exposing the internals of the cloud system to user browsers. This method also supports single sign-on and single logout by delegating these tasks to user session management and making the internal microservices and monolith applications agnostic of these tasks.

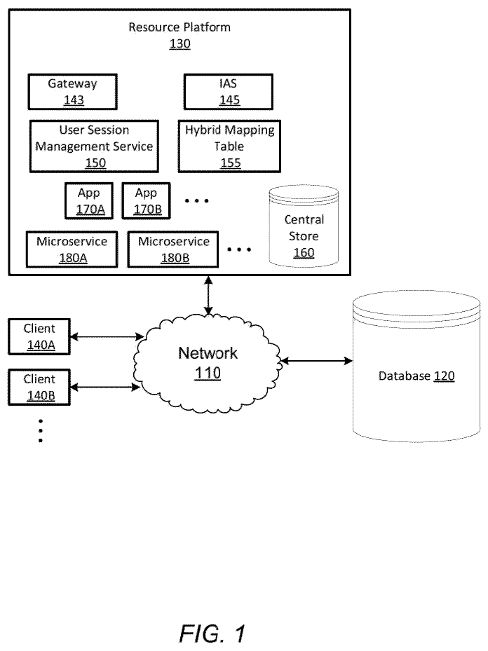

Referring now to FIG. 1, a diagram illustrating an example of a system 100 is depicted, consistent with implementations of the current subject matter. As shown in FIG. 1, the system 100 may include a resource platform 130, and resource platform 130 may provide resources that can be shared among a plurality of tenants. For example, the resource platform 130 may be configured to provide a variety of services including, for example, software-as-a-service (SaaS), platform-as-a-service (PaaS), infrastructure as a service (IaaS), and/or the like, and these services can be accessed by one or more tenants of the resource platform 130. In the example of FIG. 1, the system 100 includes a first tenant 140A (labeled client) and a second tenant 140B (labeled client as well), although system 100 may include any number of other tenants. For example, multitenancy enables multiple end-user devices (e.g., a computer including an application) as well as multiple subscribing customers having their own group of end-users with an isolated context of particular customers to access a given cloud service having shared resources via the Internet and/or other type of network 110 or communication link(s).

The resource platform 130 may include resources, such as at least one computer (e.g., a server), data storage, and a network (including network equipment) that couples the computer(s) and storage. The resource platform 130 may also include other resources, such as operating systems, hypervisors, and/or other resources, to virtualize physical resources (e.g., via virtual machines) and provide deployment (e.g., via containers) of applications (which provide services, for example, on the cloud platform, and other resources). In the case of resource platform 130 including and/or being coupled to a “public” cloud platform, the services may be provided on-demand to a client, or tenant, via the Internet. For example, the resources at the public cloud platform may be operated and/or owned by a cloud service provider (e.g., Amazon Web Services, Azure), such that the physical resources at the cloud service provider can be shared by a plurality of tenants. Alternatively, or additionally, the resource platform 130 may include and/or be coupled to a “private” cloud platform, in which case the resources of the resource platform 130 may be hosted on an entity's own private servers (e.g., dedicated corporate servers operated and/or owned by the entity). Alternatively, or additionally, the resource platform 130 may be considered a “hybrid” platform, which includes and/or is coupled to a combination of on-premises resources as well as resources hosted by a public or private cloud platform. For example, a hybrid platform may include web servers running in a public cloud while application servers and/or databases are hosted on premise (e.g., at an area controlled or operated by the entity, such as a corporate entity).

In various embodiments, the resource platform 130 provides services to client 140A-B. Each service may be deployed via a container, which provides a package or bundle of software, libraries, and configuration data to enable the cloud platform to deploy during runtime the service to, for example, one or more virtual machines that provide the service to client 140A. The service may also include logic (e.g., instructions that provide one or more steps of a process) and an interface. The interface may be implemented as an Open Data Protocol (OData) interface (e.g., HTTP message may be used to create a query to a resource identified via a URI), although the interface may be implemented with other types of protocols including those in accordance with REST (Representational state transfer). In the example of FIG. 1, there are two databases 160 and 120, although other quantities of databases may be implemented as well. The first database, central store 160, is internal to the resource platform 130, but the second database 120 is external to the resource platform 130, so an external REST type call may be used to send queries and receive responses from database 120.

Applications 170A-B are representative of any number and type of applications that are part of resource platform 130. In an example, applications 170A and 170B may be monolithic applications. When a client 140A-B first connects to resource platform 130, the client 140A-B may securely log in with identity authentication service (IAS) 145. After securely logging in, a client 140A-B may access application 170A or 170B by establishing a user session with the given application 170A or 170B. Alternatively and/or additionally, a client 140A-B may access microservices 180A-180B via the use of a token. When a client request is received by resource platform 130, gateway 143 with user session management service 150 maps the client request to the proper session ID or token via hybrid mapping table 155. For example, gateway 143 may receive a request and forward the request to user session management service 150. A unified user session identifier (ID) may be retrieved from the request by user session management service 150, and user session management service 150 may use the unified user session ID to lookup hybrid mapping table 155. The user session ID is unified in the sense that this is the only user session ID that a user needs to maintain and submit with requests in order to access multiple different monolith applications and microservices. In other words, a single unified user session ID allows the user to access multiple different monolith applications and microservices. This is possible because the hybrid mapping table 155 maps a user's unified user session ID to multiple feature-specific user session IDs and/or feature-specific tokens. Accordingly, the result of the lookup to hybrid mapping table 155 may be a feature-specific user session ID or a feature-specific token for the targeted application 170A-170B or the targeted microservice 180A-180B, respectively. Within the original request, the unified user session ID may be replaced by the feature-specific user session ID or the feature-specific token, and then the modified request may be forwarded to the targeted application 170A-170B or microservice 180A-B. More details on this process will be provided throughout the remainder of this disclosure.

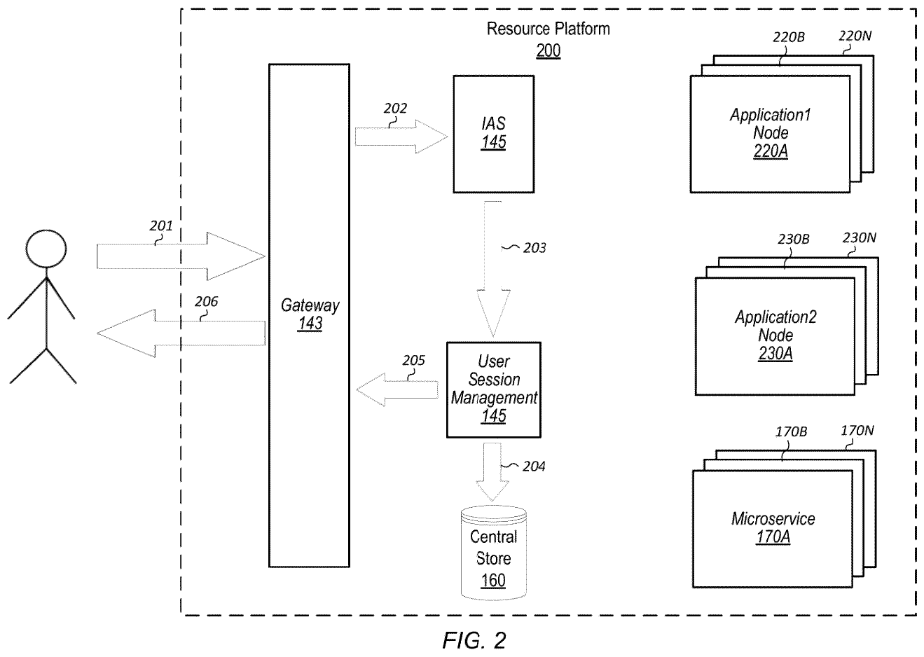

Turning now to FIG. 2, a diagram of a user session being initiated on a large scale hybrid resource platform 200 is depicted, in accordance with one or more embodiments of the current subject matter. In an example, a user session management service is closely integrated with a gateway and works as an integral part of the routing. Essentially, the gateway forwards requests to the user session management service to further decide where the requests should go.

In an example, the following sequence of activities may be utilized. When a user accesses the resource platform 200 as a fresh start, the user is not logged in yet and does not have any user session, so: (Step 201) The user accesses the platform without any session related information. (Step 202) The gateway forwards the user to identity authentication service (IAS) for single sign-on (SSO) authentication. (Step 203) The response from IAS is forwarded to User Session Management. (Step 204) User Session Management creates a primary session that includes a primary session ID for the user and puts the necessary information into a central store. It is noted that a “primary session ID” may also be referred to herein as a “unified user session ID”. (Step 205) The microservice executes the request, which can include, but is not limited to a create, read, update or delete operation in a database where the result of such execution is a response to the request and the response flows back to the gateway. (Step 206) The user receives the final response which writes the cookie that includes the primary session ID to the user's browser. It is noted that these steps are merely indicative of one particular embodiment. As will be described later, this primary session ID will be used to access both monolithic applications via nodes 220A, 220B, 220N, 230A, 230B, and/or 230N and microservices based applications 170A, 170B, and/or 170N. In other embodiments, variations to one or more of these steps and/or other steps may be employed consistent with the current subject matter.

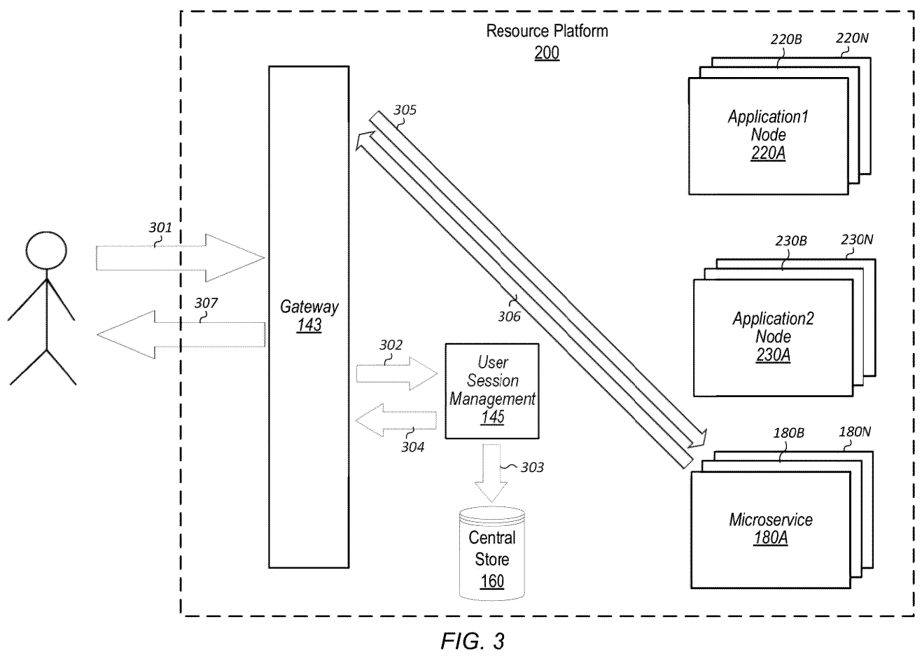

Referring now to FIG. 3, a diagram of another process flow through a hybrid resource platform 200 is shown, in accordance with one or more embodiments of the current subject matter. The process flow shown in FIG. 3 comes after the user has been authenticated as shown in FIG. 2. When a user makes a request of an application(s) that are implemented by microservices 170A-170B-170N, the following process may be employed. The request from the user is agnostic as requesting a response from a monolithic or microservices based application. (Step 301) First, the user request carries the JSESSIONID as it was written into the browser earlier (e.g., see FIG. 2 as an example). The JSESSIONID is an example of a unified user session ID that may be utilized in one embodiment. JSESSIONID is a platform session cookie and is used for session management in J2EE web applications for the HTTP protocol. The JSESSIONID may be a randomly created value. In other embodiments, other types of unified user session IDs besides JSESSIONID's may be created and utilized in the process flow for resource platform 200.

(Step 302) Next, the gateway forwards the request to User Session Management. (Step 303) By using the JSESSIONID as the key, User Session Management 145 finds the corresponding information from the central store and based on the necessary information generates a JWT token. This JWT token is stored back into the central store and can be reused for future microservice calls. (Step 304) The JWT token is put into the response. (Step 305) Gateway 143 gets the JWT token from User Session Management and modifies the original user request by adding the JWT token into the user request header, and then the modified user request is routed to the corresponding microservice. (Step 306) Microservice processes the request and generates a response. (Step 307) The response is sent back to the user using the platform session ID. It is noted that these steps are merely indicative of one particular embodiment. In other embodiments, variations to one or more of these steps and/or other steps may be utilized in accordance with the current subject matter.

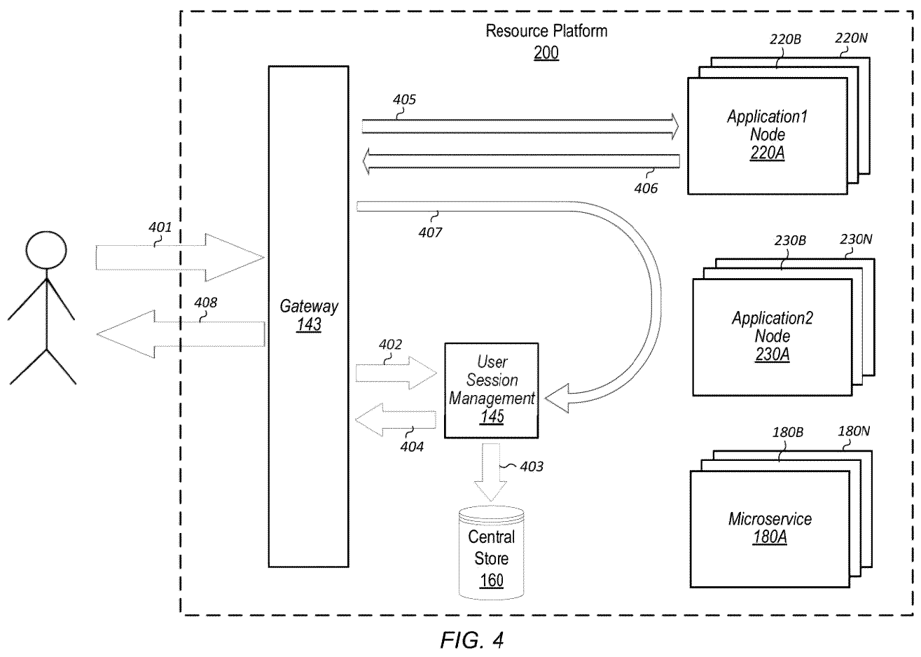

Turning now to FIG. 4, a diagram of another process flow through a hybrid resource platform 200 is shown, in accordance with one or more embodiments of the current subject matter. When it comes to accessing monolith applications, the flow is similar as to accessing a microservice but is slightly different depending on the situation. The following is an example of a sequence of events that may occur when the user accesses a monolith application the first time within a user session but after the user has been authenticated (e.g., FIG. 2, as an example): (Step 401) User request carries the JSESSIONID as it was written into the browser earlier. (Step 402) Gateway 143 forwards the request to User Session Management 145, as the gateway 143 understands this request is for monolith App1 and not a microservice, the gateway 143 modifies the request by adding two pieces of information into the request: a) an App identifier which identifies that the request is for App1, and b) a list of nodes that includes all the available nodes 220A, 220B, and 220N for App1. (Step 403) User Session Management 145 receives the request and understands this request is for App1. As this is the first request of this user session for App1, there is no information about App1 in the central store 160, so, User Session Management 145 picks up one of the available nodes and puts an identifier of the available node into the central store 160. (Step 404) After that, User Session Management 145 provides the gateway 143 with this information (e.g., the chosen node is app1-node 220A). In another embodiment, rather than user session management 145 choosing one of the nodes, gateway 143 may select one of the available nodes. (Step 405) Gateway 143 forwards the request to the chosen node (i.e., app1-node 220A in this example) from the App1. (Step 406) As this is the first request, app1-node 220A does not have any session information for this user, so the app1-node 220A creates an application-specific user session and sends the response back along with the JSESSIONID associated with the user via a Set-Cookie header. Note that this session is App1 specific, so this session is marked as JSESSIONID. App1. (Step 407) Gateway 143 forwards the response to User Session Management 145 and User Session Management 145 puts the cookie into the central store, this includes JSESSIONID. App1. (Step 408) The response is also sent back to the user with the JSESSIONID.

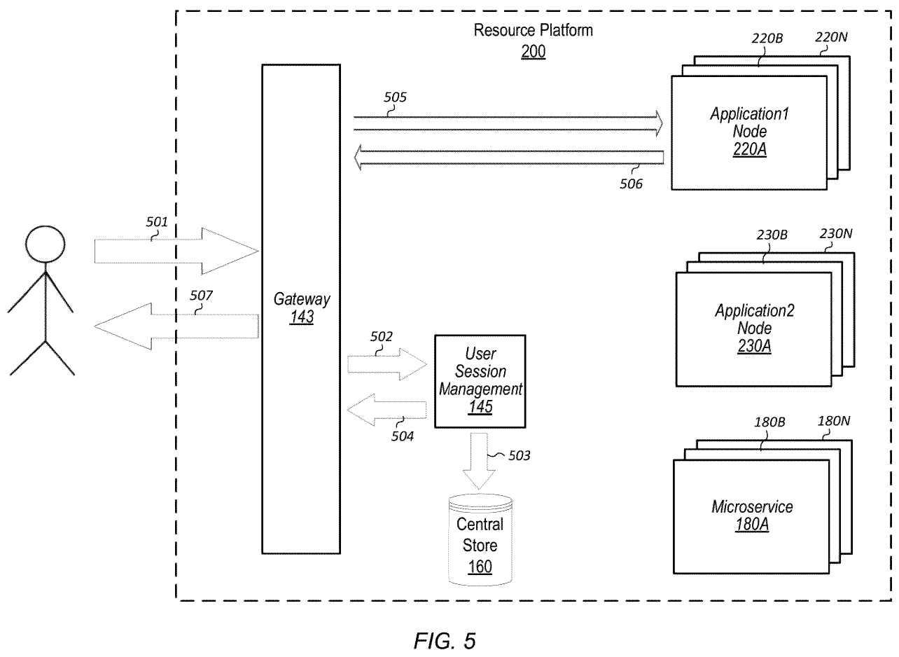

Referring now to FIG. 5, a diagram of another process flow through a hybrid resource platform 200 is shown, in accordance with one or more embodiments of the current subject matter. When the user accesses a monolith application again within an application-specific user session after having been authenticated (e.g., FIG. 2), the following steps may be performed: (Step 501) User request carries the JSESSIONID as written into the browser earlier. (Step 502) Gateway 143 forwards the request to User Session Management 145. As the gateway 143 understands that this request is for monolith App1, the gateway 143 modifies the request by adding two pieces of information into the request: a) an App identifier which identifies that the request is for App1, b) a list of nodes that includes all of the available nodes 220A, 220B, and 220N for App1. (Step 503) User Session Management 145 receives the request and understands that this request is for App1. As this is not the first request of this user session for App1 there is information about App1 in the central store 160, this includes JSESSIONID. App1 and the associated application node 220A which has the application-specific user session. (Step 504) After that, User Management Service 145 responds to the gateway 143 with this information. (Step 505) Gateway forwards the request to the specified node 220A of App1, and the request carries JSESSIONID. App1. (Step 506) With the JSESSIONID. App1 in the request, App1 can process the request by reusing the application-specific user session and sends the response back. (Step 507) The application-specific user session ID is converted to the unified user session ID (e.g., JSESSIONID) and the response is sent back to the user with the JSESSIONID.

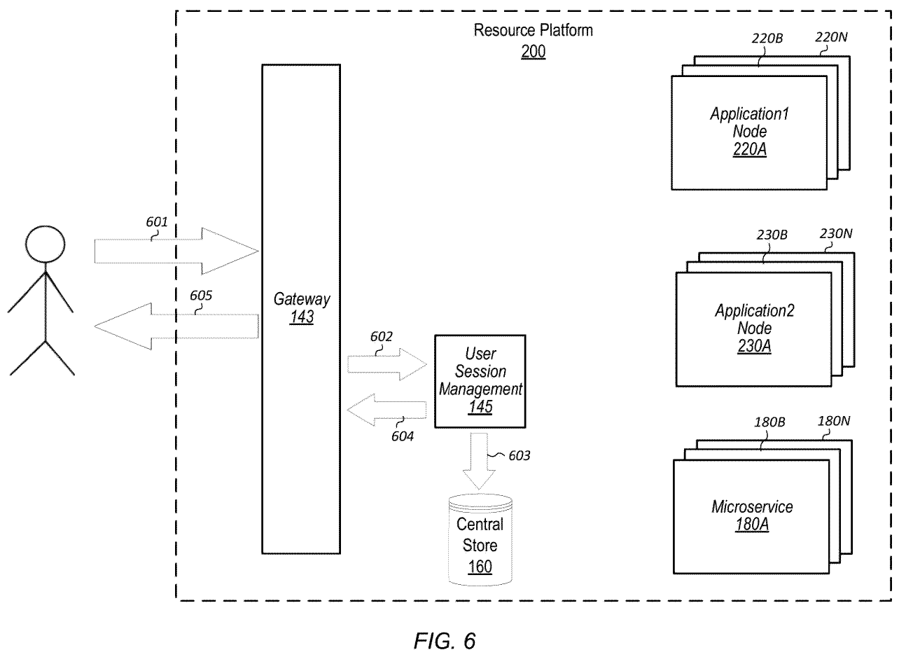

Turning now to FIG. 6, a diagram of another process flow through a hybrid resource platform 600 is shown, in accordance with one or more embodiments of the current subject matter. When the user logs out, the following sequence of events may occur: (Step 601) The user log-out request carries the JSESSIONID as it was written into the cookie earlier. (Step 602) Gateway 143 forwards the request to User Session Management 145. (Step 603) User Session Management 145 receives the request and deletes all the data under this unified user session from the central store 160. (Step 604) After that, User Management Service 145 responds to the gateway 143 with HTTP headers deleting the JSESSIONID. (Step 605) Gateway 143 sends this response back to the user. The JSESSIONID cookie is deleted from the user browser. After that, the user will not be able to access any information from the hybrid resource platform until the user re-logs in. All remaining application specific HTTP sessions in monolith applications will expire automatically over time.

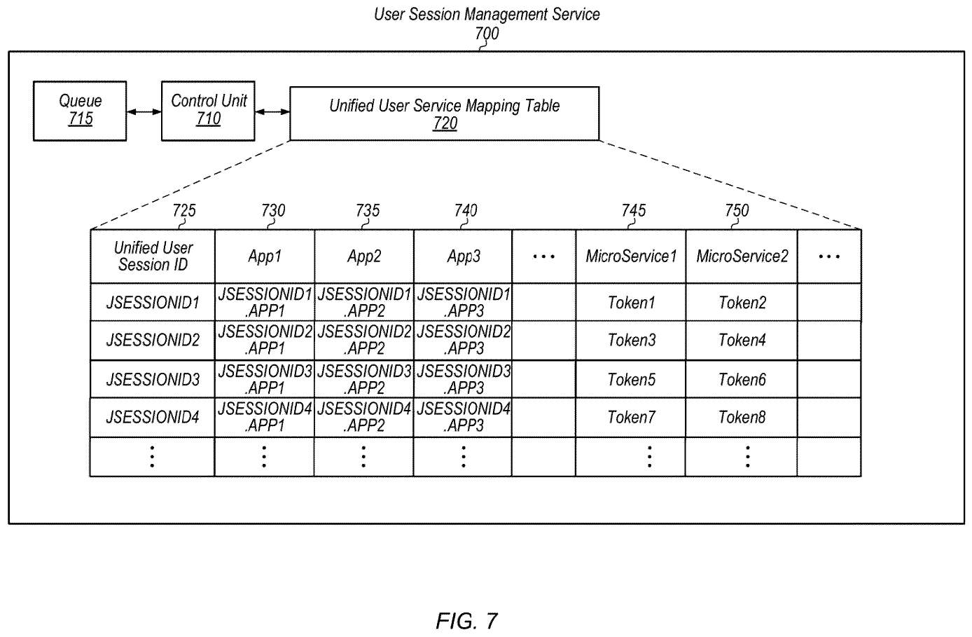

Referring now to FIG. 7, a diagram of a user session management service 700 is shown, in accordance with one or more embodiments of the current subject matter. As shown in FIG. 7, user session management service 700 may include at least control unit 710, queue 715, and unified user session mapping table 720. Control unit 710 may be implemented using any suitable combination of hardware (e.g., circuitry, logic, processing units) and software (e.g., program instructions). It is noted that unified user session mapping table 720 may also be referred to as a wrapper user session mapping table or a container user session mapping table.

An example of a unified user session mapping table 720 in accordance with one embodiment is shown expanded below unified user session mapping table 720. In other embodiments, unified user session mapping table 720 may be structured and/or arranged in other suitable manners. As shown in expanded form, unified user session mapping table 720 includes a number of rows, with each row corresponding to a single user. Each row may contain 0 or more local session IDs and 0 or more tokens. Unified user session mapping table 725 includes column 725 which stores the unified user session ID for each user that has been authenticated. Column 730 stores an application specific session ID for a first application “App1” for the corresponding user, column 735 stores an application specific session ID for a second application, and column 740 stores an application specific session ID for a third application “App3”. Unified user session mapping table 725 may include any number of other columns for storing session IDs for other applications supported by the hybrid resource platform. Unified user session mapping table 725 also includes column 745 for storing a token for a first microservice “Microservice1” for the corresponding user, and unified user session mapping table 725 includes column 750 for storing a token for a second microservice “Microservice2”. Unified user session mapping table 725 may also include any number of other columns to store tokens for other microservices supported by the hybrid resource platform.

In an example, when user session management service 700 receives a user request targeting a given software application, control unit 710 may perform a lookup of unified user service mapping table 720 for the user request. The user request may be queued in queue 715 while the lookup of unified user service mapping table 720 is being performed. In an example, control unit 710 may retrieve one or more first parameters from the user request and use the first parameter(s) to lookup unified user service mapping table 720 to retrieve one or more second parameters. In an example, the first parameters include a unified user session identifier (ID) (e.g., a JESSIONID) and an ID of the given cloud service feature being targeted. It is noted that a unified user session ID may also be referred to as a container user session ID or a wrapper user session ID. When the user request is targeting a monolith application and a user session has already been established, the second parameters may include an identification of the application and an identification of a particular node which has the user session. When the user request is targeting a microservice, the second parameter may be a token (e.g., a JWT). In either case, user session management service 700 may return the one or more second parameters to the gateway, and then control unit 710 may process the next request in queue 715.

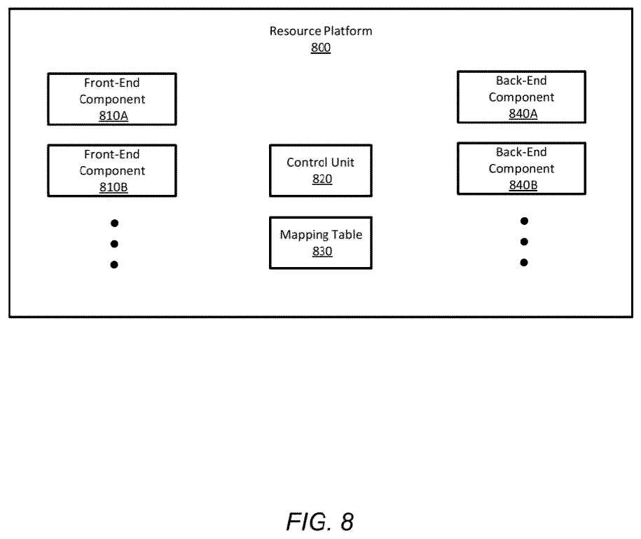

Turning now to FIG. 8, a block diagram of a generic resource platform 800 is shown, in accordance with one or more embodiments of the current subject matter. Resource platform 800 includes at least front-end components 810A-810B, control unit 820, mapping table 830, and back-end components 840A-840B. It is noted that resource platform 800 may include any number of other components which are not shown to avoid obscuring the figure. Front-end components 810A-810B may include various components for receiving and processing requests from users, where the requests are targeting one or more of back-end components 840A-840B. These front-end components 810A-810B may include a gateway, identity authentication service, user session management service, and so on. Each of these front-end components 810A-810B may be implemented using any suitable combination of hardware and software. In an example, one or more of front-end components 810A-810B are implemented as virtual machines (VMs). Back-end components 840A-840B may include various microservices and/or monolith applications. Monolith applications may include applications such as a human resources (HR) application, a goal management application, a learning application, a performance management application, and so on. Microservices may include services such as opportunity marketplace, objective key result, and so on. In an example, one or more of back-end components 840A-840B are implemented as VMs.

One or more front-end components 810A-810B may be configured to receive incoming requests which are targeting one or more of back-end components 840A-840B. When a request is received by a given front-end component 810A-810B, control unit 820 may manage user session functionality associated with the request, and control unit 820 may utilize mapping table 830 when managing the user session associated with the request. Control unit 820 and mapping table 830 may be implemented separately from front-end components 810A-810B, or control unit 820 and mapping table 830 may be implemented as part of a given front-end component 810A-810B.

As the management of the user session associated with a given request may depend on which particular back-end component is being targeted and whether the back-end component is a microservice or a monolith application, control unit 820 may process the given request based on a particular mapping in mapping table 830, where the particular mapping includes one or more pieces of data for managing a given user session associated with the given request. In an example, control unit 820 may extract one or more first parameters from the given request, and control unit 820 may utilize the one or more first parameters to perform a lookup of mapping table 830. As a result of the given lookup of mapping table 830, an entry matching the one or more first parameters may be identified. Control unit 820 may retrieve one or more second parameters from the matching entry of mapping table 830. Control unit 820 may utilize these one or more second parameters to modify and/or customize the given request, and control unit 820 may also utilize these one or more second parameters to determine how to manage the given user session. The modified and/or customized request may then be forwarded to the targeted back-end component for processing, and while the targeted back-end component is processing the modified and/or customized request, control unit 820 may manage the given user session in accordance with a given policy, where the given policy is determined based on the one or more second parameters.

Resource platform 800 may evolve over time, and some of the monolith applications may be converted into microservices. When a particular monolith application is rewritten and/or converted into a new microservice, or when a portion of the functionality of the particular monolith application is rewritten and/or converted into a new microservice, the mapping table 830 may be updated for this particular monolith application (or portion thereof) so that requests targeting this particular monolith application will be redirected toward the new microservice. Also, the way that control unit 820 manages user sessions for future requests will be modified now that the requests are targeting the new microservice and not the legacy monolith application. This transition may be seamless and may be invisible to users who are generated the requests. From the user's point-of-view, the request forwarding and user session will be managed by control unit 820 in a way that is agnostic to how the targeted back-end component is constructed.

Additionally, as resource platform 800 evolves over time, new features may be added to resource platform 800 as microservices. These microservices may be implemented as new back-end components of resource platform 800. When new features are added to resource platform 800 as microservices, control unit 820 may be updated with new logic to process requests targeting these new microservices. This may enable control unit 820 to perform the appropriate type of processing of new requests that are targeting these new features and to manage the corresponding user sessions in the appropriate manner.

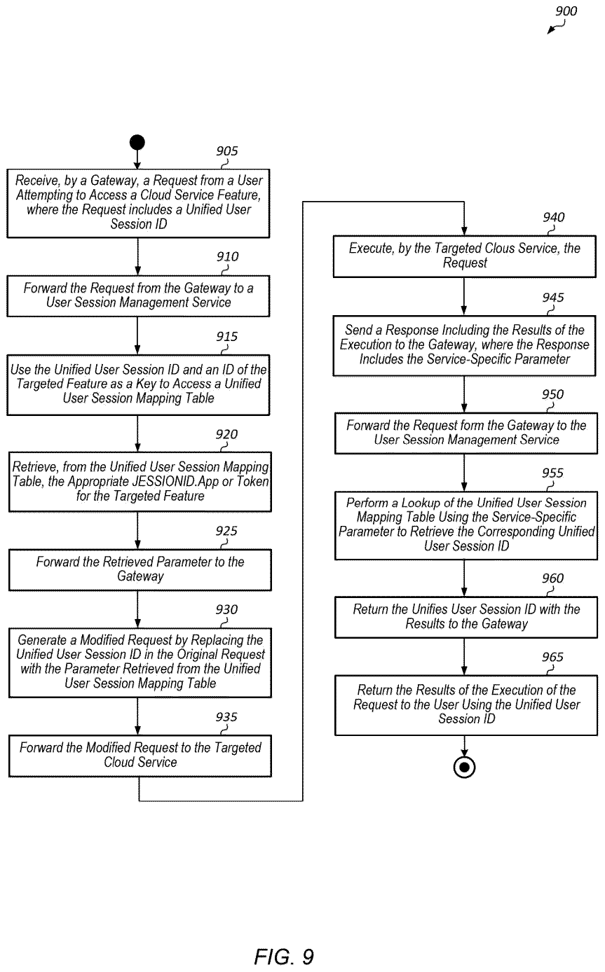

Turning now to FIG. 9, a process for employing a hybrid user session management service is depicted, in accordance with one or more embodiments of the current subject matter. At the beginning of method 900, a user request attempting to access a cloud service feature is received by a gateway, where the request includes a unified user session ID (block 905). It is noted that the unified user session ID may also be referred to as a unified JESSIONID. It is assumed for the purposes of this discussion that the user has already logged into the cloud service and has received the unified user session ID. The unified user session ID may be stored as a cookie in the user's browser. The user may be utilizing a given client device (i.e., a given user device), such as a computer, laptop, mobile device, or the like, to access the cloud service feature.

Next, the gateway forwards the request to a user session management service (block 910). Then, the user session management service uses the unified user session ID and an identification (ID) of the targeted feature as a key to access a unified user session mapping table (e.g., unified user session mapping table 720 of FIG. 7) (block 915). Next, the user session management service retrieves, from the unified user session mapping table, the appropriate JSESSIONID. App or token for the targeted feature (block 920). For example, if the user's request is targeting a monolith application, then the user session management service will retrieve, from the unified user session mapping table, a JESSIONID for the specific monolith application. Alternatively, if the user's request is targeting a microservice, then the user session management service will retrieve, from the unified user session mapping table, a token for the specific microservice. Then, the user session management service forwards the retrieved parameter to the gateway (block 925). Next, the gateway generates a modified request by replacing the unified user session ID in the original request with the parameter (e.g., JESSIONID. App, JWT) retrieved from the unified user session mapping table (block 930). The parameter retrieved from the unified user session mapping table may also be referred to as a service-specific parameter. Then, the gateway forwards the modified request to the targeted cloud service (e.g., monolith application, microservice) (block 935).

Next, the targeted cloud service executes the request (block 940). Then, the targeted cloud service sends a response including the results of the execution to the gateway, where the response includes the service-specific parameter (block 945). Next, the gateway forwards the response to the user session management service (block 950). Then, the user session management service performs a lookup of the unified user session mapping table using the service-specific parameter to retrieve the corresponding unified user session ID (block 955). Next, the user session management service returns the unified user session ID with the results to the gateway (block 960). Then, the gateway returns the results of the execution of the request to the user using the unified user session ID (block 965). After block 965, method 900 may end.

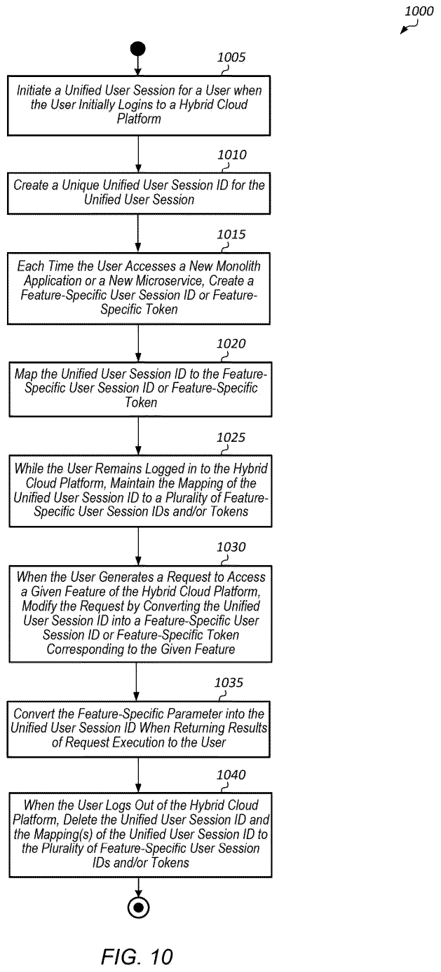

Turning now to FIG. 10, a process for managing unified user sessions is depicted, in accordance with one or more embodiments of the current subject matter. A user session management service initiates a unified user session for a user when the user initially logins to a hybrid cloud platform (e.g., resource platform 130 of FIG. 1, cloud platform 800 of FIG. 8) (block 1005). Also, the user session management service creates a unique unified user session ID (e.g., unified user session ID) for the unified user session (block 1010). Each time the user accesses a new monolith application or a new microservice, the user session management service creates a feature-specific user session ID or feature-specific token for the monolith application or microservice, respectively (block 1015). After creating the feature-specific user session ID or feature-specific token for the monolith application or microservice, respectively, the user session management service maps the unified user session ID to the feature-specific user session ID or feature-specific token (block 1020).

While the user remains logged in to the hybrid cloud platform, the user session management service maintains the mapping of the unified user session ID to a plurality of feature-specific user session IDs and/or tokens (block 1025). When the user generates a request to access a given feature of the hybrid cloud platform, the user session management service and/or gateway modifies the request by converting the unified user session ID into a feature-specific user session ID or feature-specific token corresponding to the given feature (block 1030). It is noted that the given feature of the hybrid cloud platform may refer to a given service of the hybrid cloud platform. Alternatively, the given feature of the hybrid cloud platform may refer to a given application of the hybrid cloud platform. Next, the feature-specific parameter (e.g., feature-specific user session ID, feature-specific token) is converted into the unified user session ID when returning results of request execution to the user (block 1035). When the user logs out of the hybrid cloud platform, the user session management service deletes the unified user session ID and the mapping(s) of the unified user session ID to the plurality of feature-specific user session IDs and/or tokens (block 1040). After block 1040, method 1000 may end.

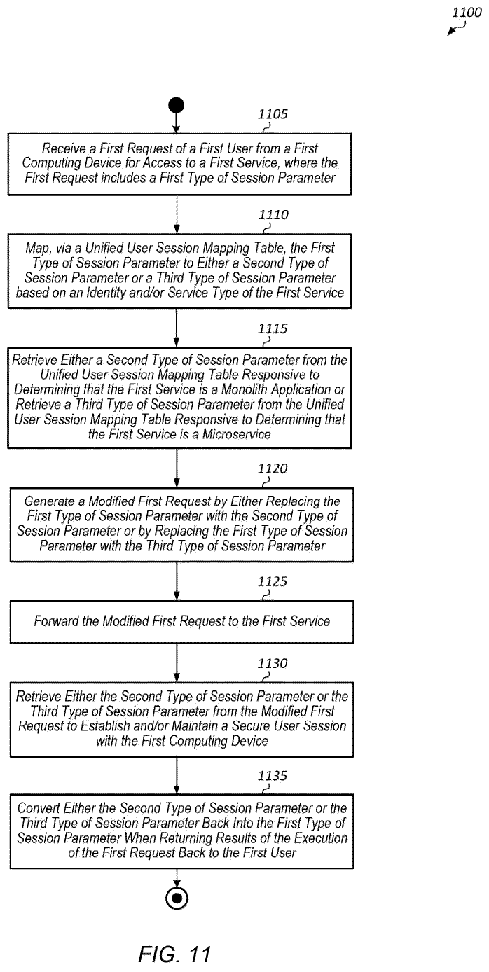

Turning now to FIG. 11, a process for utilizing a unified user session mapping table is depicted, in accordance with one or more embodiments of the current subject matter. At the beginning of method 1100, a first request is received from a first user of a first computing device for access to a first service, where the first request includes a first type of session parameter (block 1105). In an example, the first type of session parameter is a unified user session identifier (ID). The first service may be a cloud service, an on-premise service, a cloud application, an on-premise application, or some other type of feature or functionality targeted by the first request. Next, the first type of session parameter is mapped, via a unified user session mapping table, to either a second type of session parameter or a third type of session parameter based on an identity and/or service type of the first service (block 1110). It is assumed for the purposes of this discussion that the second type of session parameter is different from the first type of session parameter, that the third type of session parameter is different from the second type of session parameter, and that the third type of session parameter is different from the first type of session parameter. In an example, the second type of session parameter is an application-specific user session identifier and the third type of session parameter is a token.

After block 1110, either a second type of session parameter is retrieved from the unified user session mapping table responsive to determining that the first service is a monolith application or a third type of session parameter is retrieved from the unified user session mapping table responsive to determining that the first service is a microservice (block 1115). Next, a modified first request is generated by either replacing the first type of session parameter with the second type of session parameter or by replacing the first type of session parameter with the third type of session parameter (block 1120). Then, the modified first request is forwarded to the first service (block 1125). Next, the first service retrieves either the second type of session parameter or the third type of session parameter from the modified first request to establish and/or maintain a secure user session with the first computing device (block 1130). Then, either the second type of session parameter or the third type of session parameter is converted back into the first type of session parameter when returning results of the execution of the first request back to the first user (block 1135). After block 1135, method 1100 may end.

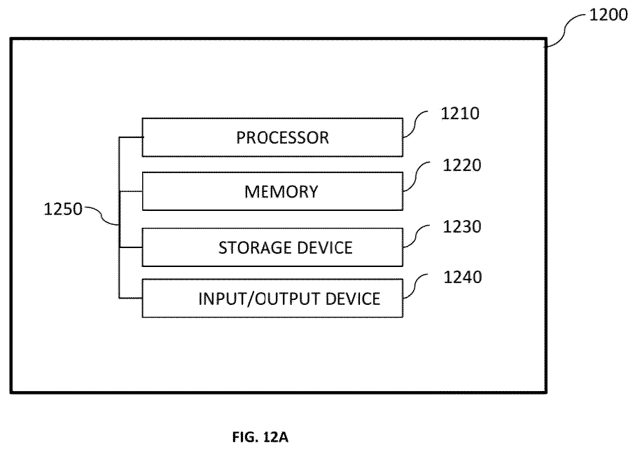

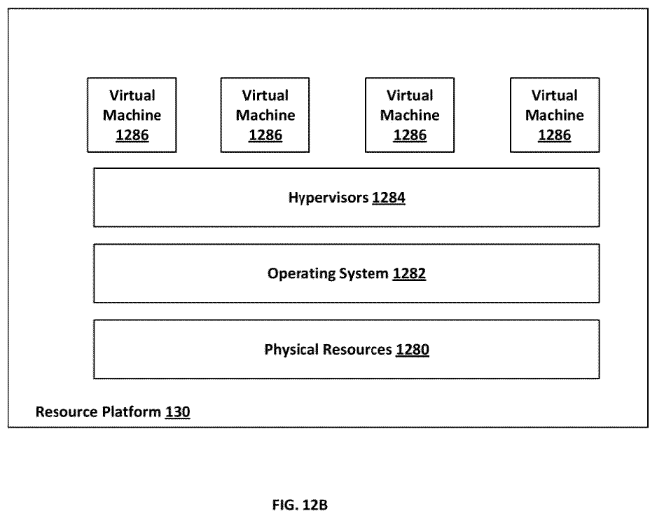

In some implementations, the current subject matter may be configured to be implemented in a system 1200, as shown in FIG. 12A. The system 1200 may include a processor 1210, a memory 1220, a storage device 1230, and an input/output device 1240. Each of the components 1210, 1220, 1230 and 1240 may be interconnected using a system bus 1250. The processor 1210 may be configured to process instructions for execution within the system 1200. In some implementations, the processor 1210 may be a single-threaded processor. In alternate implementations, the processor 1210 may be a multi-threaded processor. The processor 1210 may be further configured to process instructions stored in the memory 1220 or on the storage device 1230, including receiving or sending information through the input/output device 1240. The memory 1220 may store information within the system 1200. In some implementations, the memory 1220 may be a computer-readable medium. In alternate implementations, the memory 1220 may be a volatile memory unit. In yet some implementations, the memory 1220 may be a non-volatile memory unit. The storage device 1230 may be capable of providing mass storage for the system 1200. In some implementations, the storage device 1230 may be a computer-readable medium. In alternate implementations, the storage device 1230 may be a floppy disk device, a hard disk device, an optical disk device, a tape device, non-volatile solid state memory, or any other type of storage device. The input/output device 1240 may be configured to provide input/output operations for the system 1200. In some implementations, the input/output device 1240 may include a keyboard and/or pointing device. In alternate implementations, the input/output device 1240 may include a display unit for displaying graphical user interfaces.

FIG. 12B depicts an example implementation of the resource platform 130 (of FIG. 1). The resource platform 130 may be implemented using various physical resources 1280, such as at least one or more hardware servers, at least one storage, at least one memory, at least one network interface, and the like. The resource platform 130 may also be implemented using infrastructure, as noted above, which may include at least one operating system 1282 for the physical resources 1280 and at least one hypervisor 1284 (which may create and run at least one virtual machine 1286). For example, each multitenant application may be run on a corresponding virtual machine 1286.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together. ” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: receiving a first request from a first computing device for access to a first cloud service, wherein the first request includes a first type of session parameter; mapping, via a unified user session mapping table, the first type of session parameter to either a second type of session parameter or a third type of session parameter based on an identity and/or service type of the first cloud service; retrieving the second type of session parameter from the unified user session mapping table responsive to determining that the first cloud service is a monolith application; generating a modified first request by replacing the first type of session parameter with the second type of session parameter; and forwarding the modified first request to the first cloud service.

Example 2: The computer-implemented method of Example 1, further comprising: receiving a second request from the first computing device for access to a second cloud service, wherein the second request includes the first type of session parameter; performing a lookup of the unified user session mapping table with the first type of session parameter; retrieving the third type of session parameter from the unified user session mapping table responsive to determining that the second cloud service is a microservice; generating a modified second request by replacing the first type of session parameter with the third type of session parameter; and forwarding the modified second request to the second cloud service.

Example 3: The computer-implemented method of any of Examples 1-2, wherein the second type of session parameter is different from the first type of session parameter, and wherein the third type of session parameter is different from the second type of session parameter.

Example 4: The computer-implemented method of any of Examples 1-3, wherein the first type of session parameter is a unified user session identifier, and wherein the second type of session parameter is an application-specific user session identifier.

Example 5: The computer-implemented method of any of Examples 1-4, wherein the third type of session parameter is a token.

Example 6: The computer-implemented method of any of Examples 1-5, wherein the unified user session mapping table maps a single unified user session identifier to a plurality of parameters corresponding to a plurality of different monolith applications and a plurality of microservices.

Example 7: The computer-implemented method of any of Examples 1-6, wherein the unified user session mapping table comprises: a first entry mapping a first unified user session identifier to a first application-specific user session identifier corresponding to a first monolith application; a second entry mapping the first unified user session identifier to a first token corresponding to a first microservice; and one or more other entries.

Example 8: The computer-implemented method of any of Examples 1-7, wherein the first request is received by a gateway, and wherein the computer-implemented method further comprising forwarding the request from the gateway to a user session management service.

Example 9: The computer-implemented method of any of Examples 1-8, wherein the unified user session mapping table is accessed with the first type of session parameter and an identifier (ID) of the first cloud service.

Example 10: The computer-implemented method of any of Examples 1-9, further comprising mapping, via the unified user session mapping table, the first type of session parameter to either the second type of session parameter or the third type of session parameter based on whether the first cloud service is either a monolith application or a microservice.

Example 11: A system comprising: at least one processor; and at least one memory storing instructions that, when executed by the at least one processor, cause operations comprising: receiving a first request from a first computing device for access to a first cloud service, wherein the first request includes a first type of session parameter; mapping, via a unified user session mapping table, the first type of session parameter to either a second type of session parameter or a third type of session parameter based on an identity and/or service type of the first cloud service; retrieving the second type of session parameter from the unified user session mapping table responsive to determining that the first cloud service is a monolith application; generating a modified first request by replacing the first type of session parameter with the second type of session parameter; and forwarding the modified first request to the first cloud service.

Example 12: The system of Example 11, wherein the operations further comprise: receiving a second request from the first computing device for access to a second cloud service, wherein the second request includes the first type of session parameter; performing a lookup of the unified user session mapping table with the first type of session parameter; retrieving the third type of session parameter from the unified user session mapping table responsive to determining that the second cloud service is a microservice, wherein the third type of session parameter is different from the second type of session parameter; generating a modified second request by replacing the first type of session parameter with the third type of session parameter; and forwarding the modified second request to the second cloud service.

Example 13: The system of any of Examples 11-12, wherein the first type of session parameter is a unified user session identifier.

Example 14: The system of any of Examples 11-13, wherein the second type of session parameter is an application-specific user session identifier.

Example 15: The system of any of Examples 11-14, wherein the third type of session parameter is a token.

Example 16: The system of any of Examples 11-15, wherein the unified user session mapping table maps a single unified user session identifier to a plurality of parameters corresponding to a plurality of different monolith applications and a plurality of microservices.

Example 17: The system of any of Examples 11-16, wherein the unified user session mapping table comprises: a first entry mapping a first unified user session identifier to a first application-specific user session identifier corresponding to a first monolith application; a second entry mapping the first unified user session identifier to a first token corresponding to a first microservice; and one or more other entries;

Example 18: The system of any of Examples 11-17, wherein the first request is received by a gateway, and wherein the operations further comprise forwarding the request from the gateway to a user session management service.

Example 19: The system of any of Examples 11-18, wherein the unified user session mapping table is accessed with the first type of session parameter and an identifier (ID) of the first cloud service.

Example 20: A non-transitory computer readable medium storing instructions, which when executed by at least one data processor, result in operations comprising: receiving a first request from a first computing device for access to a first cloud service, wherein the first request includes a first type of session parameter; mapping, via a unified user session mapping table, the first type of session parameter to either a second type of session parameter or a third type of session parameter based on an identity and/or service type of the first cloud service; retrieving the second type of session parameter from the unified user session mapping table responsive to determining that the first cloud service is a monolith application; generating a modified first request by replacing the first type of session parameter with the second type of session parameter; and forwarding the modified first request to the first cloud service.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
receiving a first request from a first computing device for access to a first service, wherein the first request includes a first type of session parameter;
performing a lookup of a unified user session mapping table with the first type of session parameter, wherein the first type of session parameter maps to either a second type of session parameter or a third type of session parameter based on an identity and/or service type of the first service;
retrieving the second type of session parameter from the unified user session mapping table responsive to the first service being a monolith application;
generating a modified first request by replacing the first type of session parameter with the second type of session parameter; and
forwarding the modified first request to the first service.

2. The computer-implemented method of claim 1, further comprising:
receiving a second request from the first computing device for access to a second service, wherein the second request includes the first type of session parameter;
performing a lookup of the unified user session mapping table with the first type of session parameter;
retrieving the third type of session parameter from the unified user session mapping table responsive to the second service being a microservice;
generating a modified second request by replacing the first type of session parameter with the third type of session parameter; and
forwarding the modified second request to the second service.

3. The computer-implemented method of claim 1, wherein the second type of session parameter is different from the first type of session parameter, and wherein the third type of session parameter is different from the second type of session parameter.

4. The computer-implemented method of claim 1, wherein the first type of session parameter is a unified user session identifier, and wherein the second type of session parameter is an application-specific user session identifier.

5. The computer-implemented method of claim 4, wherein the third type of session parameter is a token.

6. The computer-implemented method of claim 1, wherein the unified user session mapping table maps a single unified user session identifier to a plurality of parameters corresponding to a plurality of different monolith applications and a plurality of microservices.

7. The computer-implemented method of claim 1, wherein the unified user session mapping table comprises:
a first entry mapping a first unified user session identifier to a first application-specific user session identifier corresponding to a first monolith application;
a second entry mapping the first unified user session identifier to a first token corresponding to a first microservice; and
one or more other entries.

8. The computer-implemented method of claim 1, wherein the first request is received by a gateway, and wherein the computer-implemented method further comprising forwarding the request from the gateway to a user session management service.

9. The computer-implemented method of claim 1, wherein the unified user session mapping table is accessed with the first type of session parameter and an identifier (ID) of the first service.

10. The computer-implemented method of claim 1, further comprising mapping, via the unified user session mapping table, the first type of session parameter to either the second type of session parameter or the third type of session parameter based on whether the first service is either a monolith application or a microservice.

11. A system comprising:
at least one processor; and
at least one memory storing instructions that, when executed by the at least one processor, cause operations comprising:
receiving a first request from a first computing device for access to a first service, wherein the first request includes a first type of session parameter;
in response to determining that an entry does not exist in a unified user session mapping table for a user of the first computing device, creating, in the unified user session mapping table, a first entry mapping the first type of session parameter to either a second type of session parameter or a third type of session parameter based on an identity and/or service type of the first service;
generating a modified first request by replacing the first type of session parameter with a second type of session parameter responsive to the first service being a monolith application; and
forwarding the modified first request to the first service.

12. The system of claim 11, wherein the operations further comprise:
receiving a second request from the first computing device for access to a second service, wherein the second request includes the first type of session parameter;
performing a lookup of the unified user session mapping table with the first type of session parameter;
retrieving the third type of session parameter from the first entry of the unified user session mapping table responsive to the second service being a microservice, wherein the third type of session parameter is different from the second type of session parameter;
generating a modified second request by replacing the first type of session parameter with the third type of session parameter; and
forwarding the modified second request to the second service.

13. The system of claim 12, wherein the first type of session parameter is a unified user session identifier.

14. The system of claim 13, wherein the second type of session parameter is an application-specific user session identifier.

15. The system of claim 14, wherein the third type of session parameter is a token.

16. The system of claim 11, wherein the unified user session mapping table maps a single unified user session identifier to a plurality of parameters corresponding to a plurality of different monolith applications and a plurality of microservices.

17. The system of claim 11, wherein the unified user session mapping table comprises:
a first entry mapping a first unified user session identifier to a first application-specific user session identifier corresponding to a first monolith application;
a second entry mapping the first unified user session identifier to a first token corresponding to a first microservice; and
one or more other entries.

18. The system of claim 11, wherein the first request is received by a gateway, and wherein the operations further comprise forwarding the request from the gateway to a user session management service.

19. The system of claim 11, wherein the unified user session mapping table is accessed with the first type of session parameter and an identifier (ID) of the first service.

20. A non-transitory computer readable medium storing instructions, which when executed by at least one data processor, result in operations comprising:
receiving a first request from a first computing device for access to a first service, wherein the first request includes a first type of session parameter;
performing a lookup of a unified user session mapping table with the first type of session parameter, wherein the first type of session parameter maps to either a second type of session parameter or a third type of session parameter based on an identity and/or service type of the first service;
retrieving the second type of session parameter from the unified user session mapping table responsive to the first service being a monolith application;
generating a modified first request by replacing the first type of session parameter with the second type of session parameter; and
forwarding the modified first request to the first service.
